(19) United States
(12) Patent Application Publication
(10) Pub. No.: US 2011/0261974 A1
(43) Pub. Date: Oct. 27, 2011

(54) OUTPUT CIRCUIT FOR AUDIO CODEC CHIP

(75) Inventor: HENG-CHEN KUO, Tu-Cheng (TW)

(73) Assignee: HON HAI PRECISION INDUSTRY CO., LTD., Tu-Cheng (TW)

(21) Appl. No.: 12/848,361

(22) Filed: Aug. 2, 2010

(30) Foreign Application Priority Data
Apr. 21, 2010 (TW) 99112559

(51) Int. Cl. H04B 15/00

(52) U.S. Cl. 381/94.1

(57) ABSTRACT

An output circuit for audio codec chip includes an audio amplifier chip and a noise eliminating circuit electrically connected to the audio codec chip and the audio amplifier chip. The audio amplifier chip receives audio signals form the audio codec chip and outputs amplified audio signals. The noise eliminating circuit includes a voltage detection circuit and a switch circuit; wherein when the voltage detection circuit detects a high voltage level power on/off signal in the audio signals received by the audio codec chip, the voltage detection circuit turns on the switch circuit. The audio amplifier chip is grounded via the switch circuit for eliminating interference of the noise signals.

### BACKGROUND

1. Technical Field

The present disclosure relates to output circuits, and particularly to an output circuit for an audio codec chip.

2. Description of Related Art

In computer systems, audio codec chips are positioned on the motherboards for outputting and receiving audio signals. A typical audio codec chip is electrically coupled to and communicates with a plurality of peripheral devices directly, such as speakers, or earphones. However, when the computer system is awakened from the sleep mode, the audio codec chip output signals jump from low voltage level to high voltage level. This voltage spike has a direct influence on the peripheral devices, and generates large amounts of noise signals.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an embodiment of an output circuit for an audio codec chip.

FIG. 2 is a circuit schematic of the power on/off signal detection circuit of FIG. 1.

FIG. 3 is a circuit schematic of the resetting signal detection circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

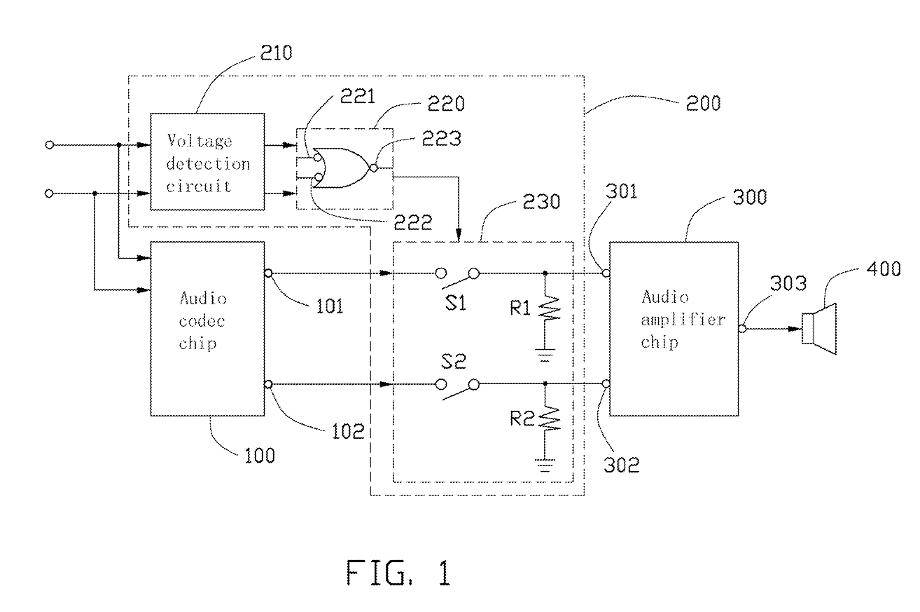

Referring to FIG. 1, an output circuit of an embodiment for an audio codec chip 100 includes a noise eliminating circuit 200, an audio amplifier chip 300 and a speaker 400. The noise eliminating circuit 200 includes a voltage detection circuit 210, a gate circuit 220, and a switch circuit 230. When the voltage detection circuit 210 detects a high voltage level power on/off signal, or a low voltage level reset signal in audio signals is received by the audio codec chip 100, the voltage detection circuit 210 turns on the switch circuit 230 via the gate circuit 220. The audio amplifier chip 300 is grounded via the switch circuit 230 for eliminating interference of the noise signals on the speaker 400.

The audio codec chip 100 includes an L-channel analog signal output terminal 101 and an R-channel analog signal output terminal 102. The switch circuit 230 includes switches S1 and S2 and resistors R1 and R2. The audio amplifier chip 300 includes an L-channel analog signal input terminal 301, an R-channel analog signal input terminal 302 and an output terminal 303. The L-channel analog signal output terminal 101 is grounded via the switch S1 and resistor R1 that are connected in series. The R-channel analog signal output terminal 102 is grounded via the switch S2 and resistor R2 which are connected in series. The L-channel analog signal output terminal 101 is electrically connected to the L-channel analog signal input terminal 301 via the switch S1. The R-channel analog signal output terminal 102 is electrically connected to the R-channel analog signal input terminal 302 via the switch S2. The output terminal 303 is electrically connected to the speaker 400.

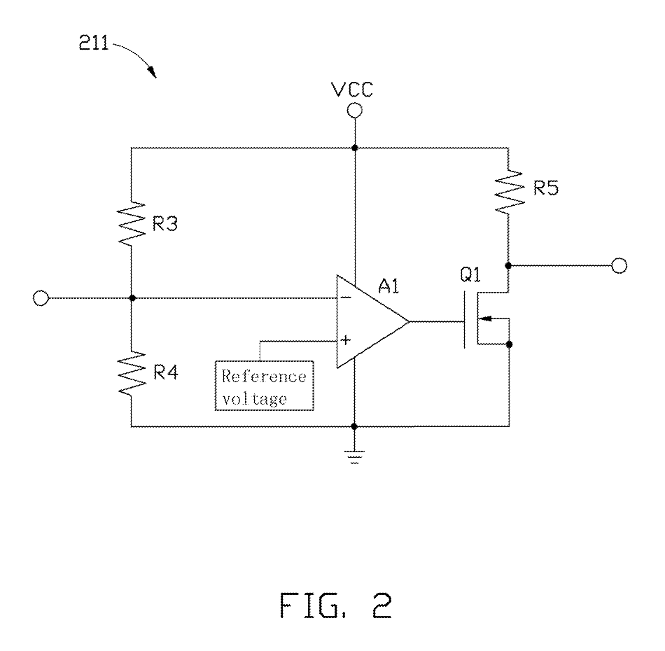

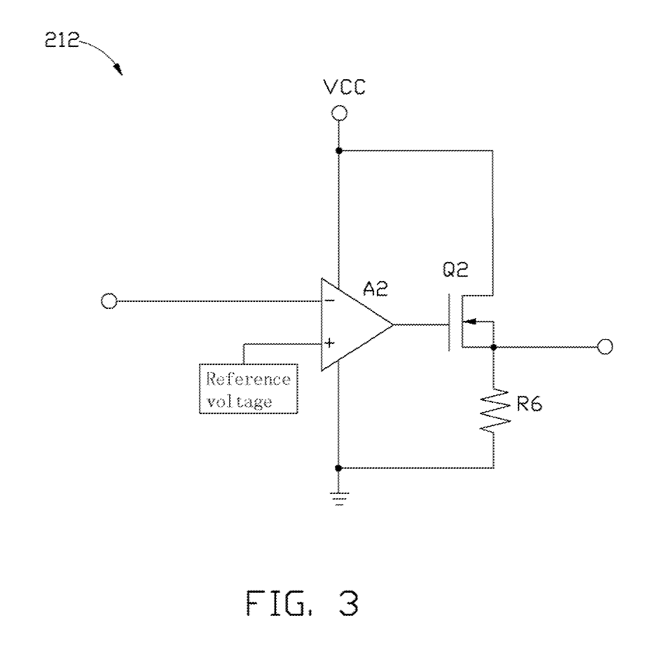

Referring to FIGS. 2 and 3, the voltage detection circuit 210 includes a power on/off signal detection circuit 211 and a reset signal detection circuit 212. The power on/off signal detection circuit 211 and reset signal detection circuit 212 detect power on/off signals and reset signals. The voltage detection circuit 210 outputs control signals to the gate circuit 220 according to the detected power on/off signals and reset signals. The power on/off signal detection circuit 211 includes a comparator A1, an N-channel MOSFET Q1 and resistors R3˜R5. A comparator A1 inverting input terminal receives a DC voltage VCC via the resistor R3. The comparator A1 inverting input terminal is grounded via the resistor R4 and receives the power on/off signals. A comparator A1 non-inverting input terminal receives a reference voltage. A comparator A1 output terminal is electrically connected to a MOSFET Q1 grid. A MOSFET Q1 source is grounded. A MOSFET Q1 drain receives the DC voltage VCC via the resistor R5. The MOSFET Q1 drain outputs the control signals.

The reset signal detection circuit 212 includes a comparator A2, an N-channel MOSFET Q2 and a resistor R6. A comparator A2 inverting input terminal receives the reset signals. A comparator A2 non-inverting input terminal receives the reference voltage. A comparator A2 output terminal is electrically connected to a MOSFET Q2 grid. A MOSFET Q2 source is grounded via the resistor R6 and outputs the control signals. A MOSFET Q2 drain receives the DC voltage VCC. The gate circuit 220 includes an OR gate having control signal input terminals 221 and 222 and an output terminal 223. The control signal input terminals 221 and 222 are electrically connected to the MOSFET Q1 drain and the MOSFET Q2 source respectively for receiving the control signals. The OR gate outputs a drive signal at the output terminal 223 to turn on/off the switches S1 and S2 according to the received control signals.

In use, the audio codec chip 100 receives the audio signals from computer system. The voltage detection circuit 210 detects the audio signals received by the audio codec chip 100. When the power on/off signal detection circuit 211 detects a high voltage level power on/off signal in the audio signals, a voltage level at the comparator A1 inverting input terminal is greater than that of the comparator A1 non-inverting input terminal The comparator A1 outputs a low voltage level. The MOSFET Q1 turns off and outputs a high voltage level control signal. When the reset signal detection circuit 212 detects a low voltage level reset signal in the audio signals, the voltage level at the comparator A2 inverting input terminal is less than that of the comparator A2 non-inverting input terminal The comparator A2 outputs a high voltage level. The MOSFET Q2 turns on and outputs a high voltage level control signal.

Thus when any high voltage level power on/off signal or low voltage level reset signal detected by the voltage detection circuit 210, the OR gate will output a high voltage level drive signal at the output terminal 223. The switches S1 and S2 turn on to separate the audio codec chip 100 and the audio amplifier chip 300. The L-channel analog signal input terminal 301 and R-channel analog signal input terminal 302 are respectively grounded via the resistors R1 and R2 When a user turns on/off or resets the computer system, the noise signals in the power on/off signal and reset signals are grounded for eliminating interference.

When the power on/off signal detection circuit 211 does not detect a high voltage level power on/off signal in the audio signals, and the reset signal detection circuit 212 does not detect a low voltage level reset signal in the audio signals, the MOSFET Q1 turns on and outputs a low voltage level control signal. The MOSFET Q2 turns off and outputs a low voltage level control signal. The OR gate outputs a low voltage level drive signal at the output terminal 223. The switches S1 and S2 turn on. The audio codec chip 100 is electrically connected to the audio amplifier chip 300 via the switch circuit 230. The audio codec chip 100 outputs normal audio signals, which are amplified by the audio amplifier chip 300 and output by the speaker 400.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An output circuit for audio codec chip, comprising:
an audio amplifier chip capable of receiving audio signals form the audio codec chip and outputting amplified audio signals; and
a noise eliminating circuit capable of eliminating noise signals and electrically connected to the audio codec chip and the audio amplifier chip; the noise eliminating circuit comprising a voltage detection circuit and a switch circuit;
wherein when the voltage detection circuit detects a high voltage level power on/off signal in the audio signals received by the audio codec chip, the voltage detection circuit turns on the switch circuit; and the audio amplifier chip is grounded via the switch circuit.

2. The output circuit for audio codec chip of claim 1, further comprising a gate circuit; wherein the voltage detection circuit is capable of detecting the high voltage level power on/off signal or a low level reset signal in the audio signals received by the audio codec chip; and the voltage detection circuit is capable of turning on the switch circuit via the gate circuit.

3. The output circuit for audio codec chip of claim 1, wherein the switch circuit comprises a first switch, a second switch, a first resistor and a second resistor; the audio codec chip comprises an L-channel analog signal output terminal and an R-channel analog signal output terminal; the L-channel analog signal output terminal is grounded via the first switch and the first resistor that are connected in series; and the R-channel analog signal output terminal is grounded via the second switch and the second resistor that are connected in series.

4. The output circuit for audio codec chip of claim 3, wherein the audio amplifier chip comprises an L-channel analog signal input terminal, an R-channel analog signal input terminal and an output terminal; the L-channel analog signal input terminal is electrically connected to the L-channel analog signal output terminal via the first switch; the R-channel analog signal input terminal is electrically connected to the R-channel analog signal output terminal via the second switch; and the audio amplifier chip output terminal is electrically connected to a speaker.

5. The output circuit for audio codec chip of claim 2, wherein the voltage detection circuit comprises a power on/off signal detection circuit and a reset signal detection circuit; the power on/off signal detection circuit is capable of detecting power on/off signals; the reset signal detection circuit is capable of detecting reset signals; the voltage detection circuit is capable of outputting control signals to the gate circuit according to the detected power on/off signals and the detected reset signals.

6. The output circuit for audio codec chip of claim 5, wherein the power on/off signal detection circuit comprises a first comparator, a first MOSFET and a third resistor; a first comparator inverting input terminal is capable of receiving the power on/off signals; a first comparator non-inverting input terminal is capable of receiving a reference voltage; a first comparator output terminal is electrically connected to a first MOSFET grid; a first MOSFET source is grounded; a first MOSFET drain is capable of receiving a DC voltage via the third resistor; and the first MOSFET drain is capable of outputting the control signals.

7. The output circuit for audio codec chip of claim 6, wherein the reset signal detection circuit comprises a second comparator, a second MOSFET and a fourth resistor; a second comparator inverting input terminal is capable of receiving the reset signals; a second comparator non-inverting input terminal is capable of receiving the reference voltage; a second comparator output terminal is electrically connected to a second MOSFET grid; a second MOSFET source is grounded via the fourth resistor; a second MOSFET drain is capable of receiving the DC voltage; and the second MOSFET drain is capable of outputting the control signals.

8. The output circuit for audio codec chip of claim 7, wherein the gate circuit comprises an OR gate having a first control signal input terminal, a second control signal input terminal and an output terminal; the first and second control signal input terminals Page 10 of 13 are electrically connected to the first MOSFET drain and the second MOSFET source respectively for receiving the control signals; and the OR gate is capable of outputting a drive signal at the output terminal to turn on/off the first and second switches according to the received control signals.

9. The output circuit for audio codec chip of claim 7, wherein the first and second MOSFETs are N channel MOSFETs.

10. An output circuit for audio codec chip, comprising:
an audio amplifier chip capable of receiving audio signals form the audio codec chip and outputting amplified audio signals; and
a noise eliminating circuit capable of eliminating noise signals and electrically connected to the audio codec chip and audio amplifier chip; the noise eliminating circuit comprising:
a voltage detection circuit comprising a power on/off signal detection circuit capable of detecting power on/off signals and a reset signal detection circuit capable of detecting reset signals;
a switch circuit; and
a gate circuit electrically connected to the voltage detection circuit and the switch circuit;
wherein when the power on/off signal detection circuit detects a low voltage level reset signal in the audio signals received by the audio codec chip, the voltage detection circuit turns on the switch circuit via the gate circuit; and the audio amplifier chip is grounded via the switch circuit.
